(19) United States
(12) Patent Application Publication
(10) Pub. No.: US 2009/0205259 A1
(43) Pub. Date: Aug. 20, 2009

(54) Resin filled composite backing for coated abrasive products and a method of making the same

(76) Inventors: Paul Burzynski, Rock Hill, SC (US); Leslie J. Branch, Homewood, IL (US)

Correspondence Address: Faier & Faier P.C., 566 W. Adams St. #600, Chicago, IL, 60661, US

(21) Appl. No.: 12/070,491

(22) Filed: Feb. 20, 2008

(51) Int. Cl. C09K 3/14

(52) U.S. Cl. 51/295; 51/297

(57) ABSTRACT

An abrasive product for removing stock from a work piece which is defined by a body of composite material consisting of layers of woven fibers bonded together and filled with epoxy-based resin and having a top coat of resin with abrasive particles embedded in the resinous top coat. The invention also includes a method for making such an abrasive product wherein the composite body has woven layers of fiber material bonded together by and filled with resin and a resinous top coat having a plurality of abrasive particular embedded therein is applied over the composite body.

### BACKGROUND AND SUMMARY OF THE INVENTION

This invention relates to resin filled composite backings for coated abrasive products and to a method of making the same, and is particularly concerned with backings having a woven or cross-webbed mesh embedded in a body of plastic resin material. Devices and methods embodying the present invention are believed to be the first use of a reinforced resin-based composite material made into a flexible coated abrasive form (“sometime hereafter referred to as RCD”).

Conventionally, the backing of most abrasive products, such as a disc, is formed from cellulose materials, such as vulcanized fibre, usually derived from rags, wood pulp or a combination of both, or other flexible backing substrates, such as polyester, cotton, polyester-cotton blends, paper and the like materials, and is used for coated abrasives and in particular disc-type products. Several layers of these fibrous materials are aggregated into rolls or sheets to a desired thickness. Abrasive grit or grains of selected materials, such as aluminum oxide, silicon carbide, corundum, diamond bort, or the like, are anchored and embedded onto the backing usually with coats of resin or adhesive, with sharp points of abrasives oriented perpendicular to the substrate.

However, coated abrasives made from conventional types of backings can be influenced by atmospheric conditions. Left exposed to dry or humid conditions, the unprotected side of the backing opposed to the abrasive side of the disc or other part will contract responsive to a dry environment or expand like a sponge responsive to a humid environment. Where a cellulose containing disc is held in inventory or stored in anticipation of use in the usual uncontrolled environment, the disc can take on undesirable shapes. Often these conditions affect the ability to mount the disc on a power tool or use the disc for the intended purpose. For example, a negative impact of atmospheric conditions may be experienced by vulcanized fibre, during production, storage and use.

The downside to all forms of conventional backings used for coated abrasive is that they can be adversely impacted by severe or hostile atmospheric conditions. Often, products left exposed for long periods in these conditions can become unusable, dangerous to use, or diminished in performance. By comparison, a resin composite backing embodying the present invention will provide an almost indefinite “shelf life”, as it is impervious to dry or humid conditions and cannot therefore be compromised in such a way.

Resin filled composites embodying the present invention provide enhanced grain retention, edge wear, durability and other advantages. Using materials and processes described in this application to provide an abrasive disc having the resin filled composite backing construction embodying the present invention have enhanced grain retention, edge wear capabilities, durability and other advantages. Other than vulcanized fibre, most coated abrasive backings are not firm, solid surfaces. Consequently, grain secured to such surfaces can “hinge” or “retract” when applied to the work surface and lead to a premature loss of useful service life. Conversely, grain that is attached to a firm resin composite backing as taught by the present invention will stay secured and engaged to optimize the useful life and performance of each individual grain.

Many manufacturers have attempted to protect coated abrasives made from conventional types of backings from these aforementioned effects by sealing them in plastic or strapping them between flat plates; and sometimes that action reduces the problem; however, where the disc is in field use, these protective measures are often ineffective, and may render the disc useless. In most cases, the shelf life of the disc is lessened, and often the cost of protective packaging unnecessarily increases the cost of the disc.

The extreme measures to protect these products from the environment is useless once the product is removed from the protective packaging. Many times these products are removed from the packaging and placed unprotected into display-type merchandising scenarios, or left unprotected by the user until consumed. Discs made from resin composite backings embodying the present invention would not be impacted by such treatment.

Usually, it is desired that coated abrasive materials made from conventional backings must have and maintain a predetermined percent of moisture, known as “equilibrium moisture content”, to eliminate brittleness and misshaping. To replace moisture lost during the resin curing process when adhering the abrasive to the disc, the discs are then subjected to a moisture reinstatement process, so the finished discs can be flexed and packaged, but this process adds to the manufacturing cycle and cost. The elimination of this moisture reinstatement process by following the present invention is a critical advantage to the use of the resin composite backing material, as this provides a significant reduction in process time and cost.

The adhering of the abrasive grit to the disc is also critical. If the abrasive grit is not suitably adhered or anchored to the backing material, the grain will shed during its use and the life of the disc will be substantially inhibited and reduced. Any inconsistency in the surface of conventional backing material may cause uneven absorption rates, variable densities or other defects, and may permit the abrasive grit to prematurely shed or strip away from the disc. Such defects are frequently not detectable during manufacture of the disc, and sometimes turn up during use. Another problem inherent in the prior art results from the overheating of the abrasive disc under work loads, as the frictional action of the disc on the work generates substantial heat, which can diminish the life of the disc.

Heat is the leading cause of premature loss of service life with regard to coated abrasives, so “fillers”, “additives” and “grinding aids” are commonly incorporated into the chemistry of the resin systems of most coated abrasive products. However, a coated abrasive made with the present resin composite backing will exhibit significantly enhanced resistance to heat generation without such additives. Additionally, the base material used in this invention is flame retardant.

Cloth based substrates can be even more challenging because of the open and flexible nature of the substrate surface. As discussed previously, these additional factors allow premature loss of grain before the useful service life of the product is exhausted.

Efforts have been made to avoid these problems by providing coated abrasive products having coated laminated backings with barrier layers of non-woen sheets for receiving an abrasive layer; for example see Follensbee U.S. Pat. No. 6,776,868, issued Aug. 17, 2004, for a COATED ABRASIVE HAVING LAMINATE BACKING MATERIAL AND METHOD OF MAKING THE SAME.

Another effort shown in the prior art to prevent delaminating of the layers of backing and grit has been to provide mechanical bonding of the layers together, as by forming the surfaces with raised and depressed areas, for example see Braunschweig et al U.S. Pat. No. 6,846,232 for BACKING AND ABRASIVE PRODUCT MADE WITH THE BACKING AND METHOD OF MAKING AND USING THE BACKING AND ABRASIVE PRODUCT, issued Jan. 25, 2005, but this process also appears to complicate the manufacture of the product. In contrast the present invention provides suitable means for bonding the backing and the grit without irregular contoured surface and without inconvenient changes in the manufacturing process.

To avoid these problems with conventional backing materials, such as vulcanized fiber or the like, the prior art demonstrates that others have molded the backing for such abrasive discs, by providing a thermoplastic binder containing a fibrous reinforcing material Related patents show the use of epoxy and hot mold resins to form the backing. However, these processes do not provide engineered regularly arranged reinforcing fibers for the backing, and are usually very hard and not flexible. Additionally, these systems provide random, irregular dispersion of the resins, affecting operation of the discs when exposed to work. Such processes are described in the following prior art patents:
Stout et al U.S. Pat. No. 5,316,812, issued May 31, 1994, for a COATED ABRASIVE BACKING, as well as its related U.S. Pat. No. 5,417,716, issued May 23, 1995, U.S. Pat. No. 5,580,634, issued Dec. 3, 1996, and U.S. Pat. No. 5,849,646, issued Dec. 15, 1998;
DeVoe et al U.S. Pat. No. 5,766,277, issued Jan. 26, 1999, for SURFACE TREATED BACKINGS FOR COATED ABRASIVE ARTICLES, as well as related U.S. Pat. No. 5,863,847, issued Jan. 26, 1999; and
Ma et al U.S. Pat. No. 6,709,738, issued Mar. 23, 2004, for COATED SUBSTRATE WITH ENERGY CURABLE CYANATE RESIN.
   The present invention not only provides an answer to these problem areas discussed in the above references, but the structure and method herein taught establishes a useful, flexible backing characteristic, which is essential to coated abrasives.

By following the present invention, an improved coated abrasive disc is made from epoxy-based resin reinforced by inner layers of tightly woven fiberglass mesh, the number, weave and thread count of which varies with the thickness of the material. This backing starts with a relatively thin layer of material, and may include a layer of coated paper attached and laminated to the engineered resin-based material, including the woven layers of fiberglass or similar fabric. This resinous matrix, which is similar to pre preg material used for making printed circuit boards, provides a suitable backing substrate. This filled substrate is then coated with a resin bonding agent that adheres to the substrate and anchors the abrasive grain to the substrate surface. The abrasive coated disc is then thermally cured, thus fusing the abrasive bonding agent and substrate to form a homogeneous lamination. A second coat of bonding agent may be applied after the initial resin system is applied to securely anchor the abrasive grain to the resin filled backing. Unlike conventional backing materials, such as vulcanized fibre or the like, the present invention does not require a reinstatement of moisture into the backing material after each resin curing process.

The engineered reinforced mesh substrate used in making the backing may include selected fillers, which may be glass beads or other inert materials, the purpose of which may be added structural reinforcement and which may conduct heat out of the composite backing material in heavy grinding applications. By virtue of the makeup of the herein disclosed novel resin filled backing, the disc retains its shape and is impervious to atmospheric conditions and has virtually unlimited shelf life. Devices embodying the invention could be merchandised openly and unprotected without detailed plastic or other packaging. Also, during manufacturing, reintroducing moisture to the product would be unnecessary. The potential for grain stripping or shedding and overheating would also be substantially inhibited by using the method disclosed.

A reinforced mesh substrate of the character described may be flame resistant and have very high tolerance to heat, which also improves its usefulness under work load, particularly when working on heat sensitive materials.

This fiberglass or like reinforced mesh backing material embodying the present invention can be formed in rolls or sheets or in individual disc forms, and is thus versatile and able to be processed and fabricated without substantial waste material, and is thus adaptable for use in many applications for stable backing materials and manufacturing processes. Further, the shape of the backing disc can be fabricated by a laser cutting process and can be processed into a precut form or shape to avoid unnecessary die cutting processes.

### OBJECTS AND ADVANTAGES OF THE INVENTION

It is the object of this invention to provide a resin filled composite backing for an abrasive product, such as a disc, strips, and/or other potential shapes and forms of the character described.

Another object is to provide a backing for an abrasive product, such as a disc or other abrasive product, having a woven body of fiberglass or like mesh fabric.

Another object is to provide a laminate comprising a thin layer of material, such as paper or other material, thermally bonded to a resin filled fiberglass or similar mesh fabric.

Another object is to provide a laminated backing for an abrasive product, such as a disc or similar product, which includes thermally conductive filler material for providing added structural strength and to dissipate heat during use.

Another object is to provide a laminated layer of woven fiberglass or like mesh fabric which has high tolerance to heat and which is flame resistant and is able to receive and embed abrasive grains securely anchored to an abrasive product, such as a disc, even under substantial work loads.

Another object is to provide a laminated layer of woven fiberglass or like mesh fabric which is able to receive and embed abrasive grains to securely anchor the abrasive grains to its substrate even under substantial work loads.

Another object is to provide an abrasive product, such as a disc or the like, formed of a laminated body which includes woven fiberglass or mesh fabric and which will retrain its shape, resist warping and remain semi-flexible during its life and under work loads.

Another object is to provide a novel method for making and assembling a backing for an abrasive product which includes the use of a woven resinated mesh fabric material.

Another object is to provide an improved coated abrasive product which is simple and economical to manufacture, efficient to sell and market, and relatively easy to handle and use.

These and other objects and advantages will become more apparent as this description proceeds, taken in conjunction with the accompanying drawings.

### BRIEF DESCRIPTION OF THE DRAWINGS

In the drawings:

FIG. 1 is a plan view of one typical abrasive disc embodying the present invention, viewed from its abrasive side.

FIG. 2 is a plan view of the typical abrasive disc embodying the present invention, viewed from its reverse side, where a disc is connected to a tool by an arbor fastener or the like.

FIG. 3 is a perspective view of an abrasive disc on a grinding machine.

FIG. 4 is a partial cross-sectional view of the abrasive disc shown in FIG. 1, taken on line 2-2 of FIG. 1.

FIG. 5 is a view similar to FIG. 5, except with a layer of paper or similar thin material at the bottom of the substrate.

### DESCRIPTION OF THE PREFERRED EMBODIMENT

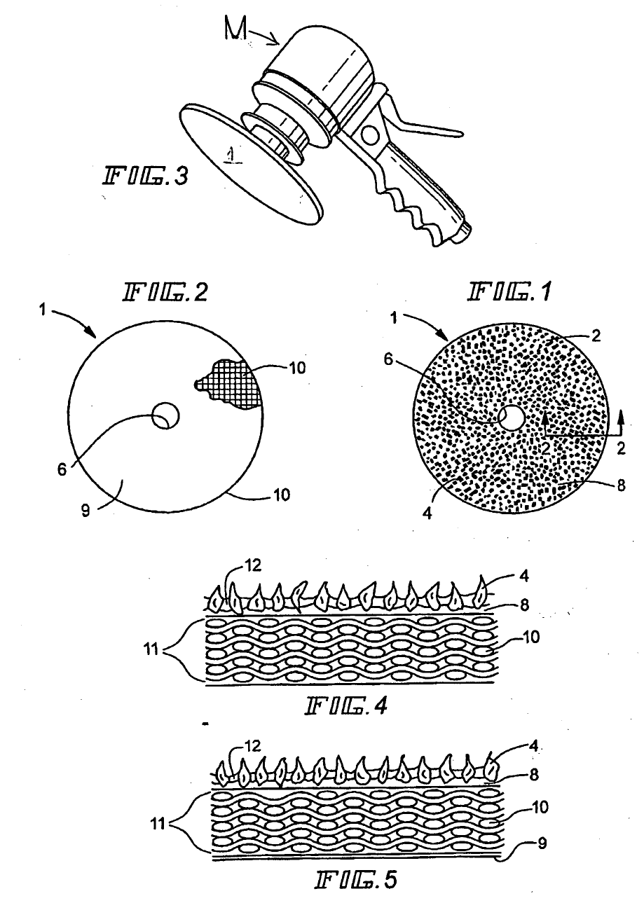

Typically, an abrasive disc 1 is rotatably mounted on the threaded shaft of a grinding machine M, and is used to abrade a work piece by grinding, finishing or the like. The disc 1 comprises a body 2, the face of which is covered by sharp pieces of abrasive particles or grain 4. The disc 1 is often removably secured on a pad, which may be mounted on the threaded shaft of the machine (FIG. 3 embodiment) or by a fastener secured through an aperture 6 formed through the disc (FIGS. 1 and 2 embodiment).

Other means for mounting the disc onto a pad or other holding media may also be typically provided, such as producing a disc with or without a center arbor hole, or with varying fastening devices such as mechanical locking, hook and loop, pressure sensitive adhesive or other attachment systems. The abrasive grains 4 are usually secured in and extend from a bed 8 intended to hold the grains in working position without being stripped from the body 2.

The body 2 or backing embodying the present invention comprises a substrate 11 of resin filled fiberglass or similar mesh fabric layers 10 or other mesh reinforcement, which has a weave thickness and density, predicated by the desired overall thickness and flexibility of the backing substrate, which is typically of a dimension of 0.010″ to 0.050″. The body 2 may also include a thin layer of coated paper 9 attached to the substrate 11. The layers of mesh filled resin substrate 10, which may include paper 9, are bonded together to form the single substrate 11 by means of a resin filling agent, which may be epoxy, modified for specific viscosity by the addition of micro spheres, such as glass beads or micro fibers or other fillers and additives. This filled lamination is then thermally cured. This filled lamination may be formed in a coil or a slab or in the shape of the abrasive disc. If formed from a coil or slab, it may be die cut to size.

Abrasive grains 4, such as aluminum oxide, alumina zirconia, silicon carbide, ceramic aluminum oxide or other abrasive grains are introduced to the substrate body 2 by means of gravity or electrostatic processes. A second resin system 12, usually phenolic, is then used to permanently secure the individual abrasive grains 4 into place. This resin system 12 may contain chemical compounds to enhance the cutting action of the grains and to reduce heat generation during use. The quantity or weight of this second resin system may fluctuate depending upon the abrasive grain size and disc type. The grains 4 used may vary from about 16-120 grit (or finer), depending upon the work intended for the finished disc or other product.

The inner layers for the backing formed from the woven fiberglass or like mesh fabric and coated paper is relatively flexible as compared to reinforced fiber or molded plastic materials of the prior art. This flexibility, which can be controlled by the exact mesh and other material used, provides a disc or other configuration which is adequately flexible to reach all surfaces of the work piece to be reached. When heated during the lamination process described, the substrate of mesh fabric, any coated paper and resinous filling agent cross linked into a bonded homogeneous body, suitable, with a second coat of abrasive grain and its bonding agent, will hold the completed disc together under work loads. When thermally cured, this substrate is not adversely affected by humidity and has enhanced thermal conductivity under work loads. The abrasive disc embodying the present invention also allows the periphery of the disc to be “pinched” or “snagged” during operation, while vulcanized fiber backing discs can shatter under such circumstances.

A coated abrasive disc embodying the present invention, including the resinous bonded substrate described above, has distinct advantages over conventional discs, even those formed with cloth based substrates, not only because of superior abrasive bonding to the substrate, but also because of greater edge durability and flexibility, as well as the ability to use the tool in wet or dry environments.

While a preferred embodiment of the present invention has been disclosed and described in considerable detail, many changes and modifications to the structure and method can be made without departing from the scope of the invention. Accordingly, it is not desired that the invention should be limited to the exact construction shown and described.

1. An abrasive product for removing stock from a work piece, said product comprising a body of composite material consisting of layers of woven fibers bonded together and filled with epoxy based resin, said body having a top coat of resin, and a plurality of abrasive particles embedded in said top coat.

2. The abrasive product recited in claim 1, wherein said body is substantially impervious to dry and humid conditions.

3. The abrasive product recited in claim 1, wherein said body is firm, solid and flexible.

4. The abrasive product recited in claim 1, wherein said body has a regular level surface.

5. The abrasive product recited in claim 1, wherein said resins are dispersed regularly throughout said body.

6. The abrasive product recited in claim 1, wherein said woven fibers are fiberglass mesh.

7. The abrasive product recited in claim 1, wherein a second coat of resin has been applied over said top coat.

8. The abrasive product recited in claim 7, wherein said second coat is applied over said abrasive particles.

9. The abrasive product recited in claim 1, wherein fillers are dispersed in said body.

10. The abrasive product recited in claim 10, wherein said fillers contain glass beads.

11. The abrasive product recited in claim 10, wherein said fillers contain micro fibers.

12. The abrasive product recited in claim 1, wherein said body comprises thermally conductive material.

13. The abrasive product recited in claim 1, wherein said body has a layer of thermally bonded paper remote from said top coat.

14. The abrasive product recited in claim 1, wherein said top coat is formed from phenolic resin.

15. The abrasive product recited in claim 1, wherein said body is flame resistant.

16. The abrasive product recited in claim 1, wherein said product is fabricated into the shape of a disc, strip or other form.

17. A method for making an abrasive product comprising the steps of forming a body of composite material consisting of woven layers of fiber material bonded together and filled with resin, applying a top coat of resin to said body, and embedding a plurality of abrasive particles in said top coat.

18. A method for making an abrasive product recited in claim 17, wherein said body is formed in a roll, sheet, coil, or slab and cut into the form of an abrasive product before said top coat is applied.

19. A method for making an abrasive product recited in claim 17, with the additional step of cutting said product into the shape of a disc, strip or other form after said particles are embedded in said top coat.

20. A method for making an abrasive product recited in claim 17, wherein a layer of paper is thermally bonded to said body.

21. A method for making an abrasive product recited in claim 17, wherein another coat of resin is applied over said top coat.
